(19) United States
(12) Patent Application Publication
(10) Pub. No.: US 2016/0131889 A1
(43) Pub. Date: May 12, 2016

(54) OPTICAL DEVICE FOR USE WITH COHERENT TERAHERTZ LIGHT

(71) Applicant: NEC CORPORATION, Tokyo (JP)

(72) Inventors: Takao MORIMOTO, Tokyo (JP); Takayuki SUDOU, Tokyo (JP)

(21) Appl. No.: 14/898,524

(22) PCT Filed: Jun. 20, 2014
(86) PCT No.: PCT/JP2014/003324

§ 371 Date: Dec. 15, 2015

(30) Foreign Application Priority Data
Jul. 1, 2013 (JP) 2013-137713

(51) Int. Cl. G02B 21/36; G01J 1/04; G01J 1/42

(52) U.S. Cl. CPC G02B 21/361; G01J 1/42; G01J 1/0407

(57) ABSTRACT

[Object] To provide an optical device for use with coherent terahertz light, which enables to reduce and remove an unwanted interference pattern, and to acquire a terahertz image of high image quality.

[Solving Means] The optical device for use with coherent terahertz light includes an optical system (2) that uses coherent terahertz light beam (1) whose frequency(ies) is/are within a range from 0.1 to 10 THz. A structure(s) (4) being located outside of effective diameter (3) of the beam (1) and including anti-reflection material (5) on an area(s) of the structure, the area(s) is/are facing to the beam (1).

### TECHNICAL FIELD

The present invention relates to an optical device for use with coherent terahertz light.

### BACKGROUND ART

A terahertz wave, which is an electromagnetic wave having a frequency of from 0.1 to 10 THz (wavelength of from 30 μm to 3 mm) has been attracting attention on the basis of the findings that the terahertz wave is harmless unlike an X-ray, when being transmitted through a material such as plastic, paper, or clothes, and that there is a fingerprint spectrum unique to a terahertz range. There has been no appropriate light source in a terahertz range for a long time. In recent years, however, it has become possible to obtain a stable light source by using a quantum cascade laser. Research and development on a terahertz wave have remarkably progressed by the aforementioned findings. For instance, a terahertz microscope incorporated with a quantum cascade laser, as disclosed in NPL 1, has been developed.

FIG. 15 illustrates a configuration of the terahertz microscope. A coherent terahertz light source 102 for outputting a coherent terahertz wave, and an illumination optical system are accommodated in a housing 101. A sample stage 103 is provided in the next part of the illumination optical system. An observation optical system and a terahertz camera 105 accommodated in a lens barrel 104 are provided in the next part of the sample stage 103. According to this configuration, a terahertz image of a sample 106 mounted on the sample stage 103 is captured by the terahertz camera 105.

In NPL 1, the coherent terahertz light source 102 is a quantum cascade laser, and the frequency of the coherent terahertz light source 102 is 2.83 THz (wavelength: 106 μm). A first lens 107, a mirror 108, an iris diaphragm 109, and a second lens 110 are provided in the illumination optical system. The sample stage 103 is provided in the next part of the illumination optical system. An objective lens 111, an infrared cut filter 112, and an eyepiece lens 113 are provided in the observation optical system. The terahertz camera 105 is installed in the next part of the eyepiece lens 113. The observation optical system and the terahertz camera 105 are supported by an arm 114. Further, the first lens 107 is supported by a lens holder 115, and the mirror 108 is supported by a mirror holder 116.

A sensor package 117 is incorporated in the terahertz camera 105. An array sensor 118 is sealed in the sensor package 117. A window 119 is formed in a terahertz light incident portion of the sensor package 117.

Light output from the coherent terahertz light source 102 is collected with the first lens 107. The collected light is reflected with the mirror 108, and the reflected light is collected at the position of the iris diaphragm 109. Subsequently, unwanted light is removed by the iris diaphragm 109. Light that has been transmitted through the iris diaphragm 109 is collimated by the second lens 110, and the collimated light is irradiated on the sample 106, which is mounted on the sample stage 103. Light that has been transmitted through the sample 106 is incident on the terahertz camera 105 via the observation optical system. In this way, a terahertz image of the sample 106 is acquired. Note that the magnification can be adjusted by changing the combination of the objective lens 111 and the eyepiece lens 113.

### CITATION LIST

### Non Patent Literature

### NPL 1

“Real-Time Transmission-type Terahertz Microscope, with Palm size Terahertz Camera and Compact Quantum Cascade Laser”, Proc. of SPIE, August, 2012, vol. 8496, pp. 84960Q-1 to 84960Q-11 by Oda and other eight persons

### SUMMARY OF INVENTION

### Technical Problem

The terahertz microscope disclosed in NPL 1, however, has a problem that an interference pattern is generated on a background image, which makes a sample image unclear. This is a problem resulting from diffraction and interference unique to coherent terahertz light. The details are as described below.

The first problem is that light is affected by diffraction. This is because the wavelength of terahertz light is longer than the wavelength of visible light by two or three digits. In a microscope for use with visible light, the wavelength is 1 μm or smaller, which is smaller than the size of an optical component by three orders of magnitude at least. Therefore, diffraction hardly becomes a problem. Further, it is possible to specify the generation position of unwanted light solely by ray tracing using geometric optics. Therefore, measures for preventing reflection are available. On the other hand, the wavelength of terahertz light is from 0.03 to 3 mm, which is smaller than the lens diameter or the mirror diameter by one to two orders of magnitude. The wavelength of terahertz light is close to the order of the size of an optical system. Therefore, the influence of diffraction may not be ignored. Specifically, the beam diameter may expand when light travels a short distance. Expansion of the beam diameter may make it difficult to prevent generation of unwanted light such as reflection from a lens frame or vignetting by a diaphragm.

Comparison on expansion of the beam diameter is made by practical examples. When visible light having a wavelength of 0.5 μm is used, the beam diameter of 10 mm of a Gaussian parallel beam (beam diameter: 1/e²) expands only to the beam diameter of 10.00002 mm, even when the light travels by 30 cm. On the other hand, when light having a wavelength of 0.6 mm, specifically, having a frequency of 0.5 THz is used, the beam diameter of 10 mm expands to the beam diameter of 25 mm when the light travels by 30 cm.

The second problem is that interference of unwanted light as described is noticeable. One of the reasons is that coherence of light itself is high. Another reason is that coherence is not lost even in scattered light from an optical component because the wavelength of the light is long. For instance, a processing variation of a lens frame is 1 μm or more. As far as visible light is used, the phase of scattered light becomes random, and coherence is lost. As a result, interference fringes are not generated. On the other hand, the wavelength of terahertz light is larger than the processing variation. Therefore, coherence is not lost even in scattered light. As a result, interference fringes by scattered light may be generated.

In view of the aforementioned problems, an object of the invention is to provide an optical device for use with coherent terahertz light, which enables to reduce and remove an unwanted interference pattern, and to acquire a terahertz image of high image quality.

### Solution to Problem

In order to solve the aforementioned problems, an optical device for use with coherent terahertz light of the invention includes an optical system that uses coherent terahertz light beam whose frequency(ies) is/are within a range from 0.1 to 10 THz; and

a structure(s) being located outside of effective diameter of the beam and including anti-reflection material on an area(s) of the structure, the area(s) is/are facing to the beam.

### Advantageous Effects of Invention

An advantageous effect of the invention is that the image quality of a coherent terahertz light image is improved.

### BRIEF DESCRIPTION OF DRAWINGS

FIG. 1 is a sectional view illustrating a first exemplary embodiment of the invention.

FIG. 2 is a sectional view illustrating an optical device in a second exemplary embodiment of the invention.

FIG. 3 is a sectional view illustrating a terahertz camera of NPL 1.

FIG. 4 is a sectional view illustrating a terahertz camera of the invention.

FIG. 5 is a sectional view illustrating an optical device in a third exemplary embodiment.

FIG. 6 is a sectional view illustrating a lens in a fourth exemplary embodiment of the invention.

FIG. 7 is a sectional view illustrating a mirror in the fourth exemplary embodiment of the invention.

FIG. 8 is a plan view illustrating an iris diaphragm in the fourth exemplary embodiment of the invention.

FIG. 9 is a diagram illustrating an example of a terahertz image acquired when a metal frame is not disposed on an optical path.

FIG. 10 is a diagram illustrating an example of a terahertz image acquired when a metal frame, to which the invention is not applied, is disposed.

FIG. 11 is a diagram illustrating an example of a terahertz image acquired when a metal frame employing the invention is disposed.

FIG. 12 is a sectional view illustrating a fifth exemplary embodiment of the invention.

FIG. 13 is a sectional view illustrating a sixth exemplary embodiment of the invention.

FIG. 14 is a schematic diagram illustrating a seventh exemplary embodiment of the invention.

FIG. 15 is a sectional view illustrating an optical device of NPL 1.

### DESCRIPTION OF EMBODIMENTS

In the following, exemplary embodiments of the invention are described in detail with reference to the drawings.

### First Exemplary Embodiment

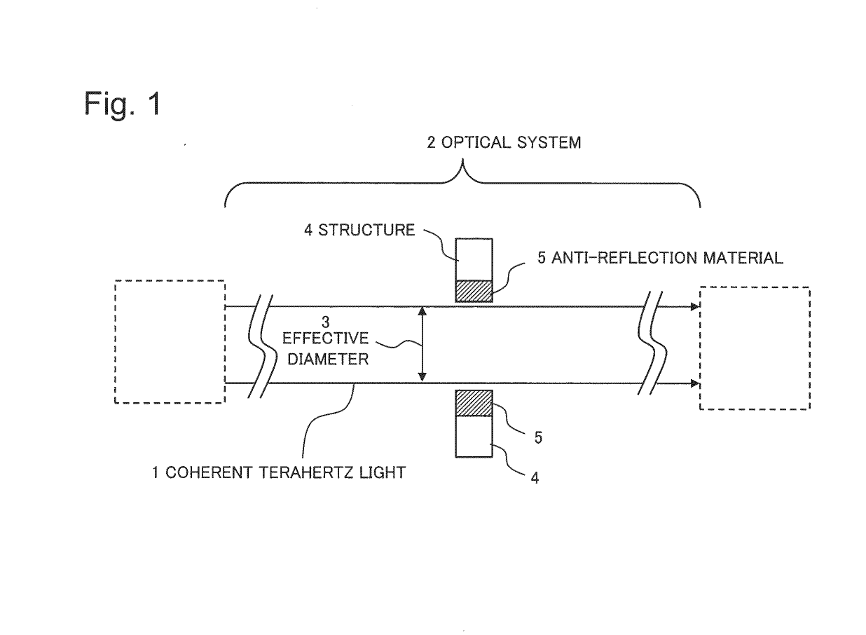

FIG. 1 is a sectional view illustrating the first exemplary embodiment of the invention. An optical device for use with coherent terahertz light in the exemplary embodiment includes an optical system 2 which uses coherent terahertz light 1 whose frequency(ies) is/are within a range from 0.1 to 10 THz. Further, a structure 4 located on the outside of an effective diameter 3 of the optical system 2 includes anti-reflection material 5 on the area facing to the effective diameter 3. Although not illustrated, the optical system 2 may be provided with various optical means for controlling the coherent terahertz light 1.

According to the exemplary embodiment, it is possible to eliminate an influence of diffraction and interference of coherent terahertz light to thereby obtain a coherent terahertz light image of high image quality.

### Second Exemplary Embodiment

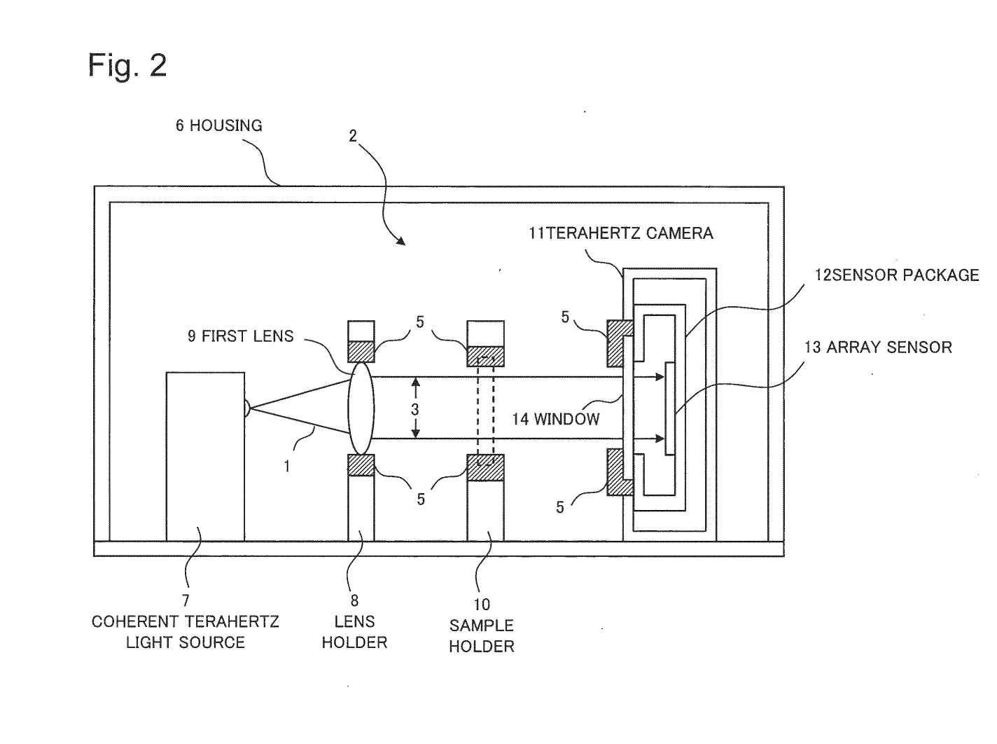

FIG. 2 is a sectional view illustrating an optical device in the first exemplary embodiment of the invention. A coherent terahertz light source 7 which outputs coherent terahertz light 1, a first lens 9 supported on a lens holder 8, a sample holder 10, and a terahertz camera 11 are provided in a housing 6. A sample is mounted on the sample holder 10. It is desirable that a sample is detachably mounted. Further, an anti-reflection material 5 is formed on a lens holding portion of the lens holder 8, and on a sample holding portion of the sample holder 10 on the optical path side. The anti-reflection material 5 is formed to cover the diffraction range of terahertz light.

The optical device illustrated in FIG. 2 is configured such that an optical system 2 is constituted by the coherent terahertz light source 7, the first lens 9, an opening portion of the sample holder 10 where a sample is mounted, and the terahertz camera 11. When a sample is mounted, the sample is also included. The effective diameter 3 of the optical system 2 is included in a ray tracing area by the geometric optics. In this example, the light emission area from the coherent terahertz light source 7, the light input/output area of the first lens 9, and the light incident area on the terahertz camera 11 in the geometric optics correspond to the effective diameter 3. Structures located on the outside of the effective diameter 3 are the lens holder 8, the sample holder 10, and a portion of the terahertz camera 11 other than the light incident portion thereof. In the exemplary embodiment, the anti-reflection materials 5 are formed on the areas of the structures, the areas are the outside of the optically effective diameter 3 of the structures. Specifically, the anti-reflection material 5 is formed on the lens holding portion of the lens holder 8 which supports the first lens 9, the sample holding portion of the sample holder 10, and a portion of the terahertz camera 11 on the outside of the light incident portion of the terahertz camera 11.

A sensor package 12 is incorporated in the terahertz camera 11. An array sensor 13 for detecting terahertz light is sealed in the sensor package 12. Further, a window 14 for transmitting terahertz light is formed in the light incident portion of the sensor package 12. The anti-reflection material 5 is formed around the window 14. The array sensor 13 is a unit in which terahertz light sensor elements (not illustrated) are arranged in an array.

Next, an operation to be performed by the optical device is described. The coherent terahertz light 1 output from the coherent terahertz light source 7 is collimated by the first lens 9, and the collimated light is irradiated on a sample. The coherent terahertz light 1 that is transmitted through the sample is incident on the terahertz camera 11. The transmitted terahertz light is transmitted through the window 14, and is incident on the array sensor 13. Thus, an image of the sample is acquired.

In the following, unwanted light with respect to an observation image is described. FIG. 2 illustrates an optical path by ray tracing using the geometric optics. The actual rays, however, expand by diffraction. These rays are unwanted light with respect to observation. In the exemplary embodiment, the expanded rays are absorbed or are made incoherent by the anti-reflection material 5 formed on each of the optical elements. Thus, image blur by interference of unwanted light is prevented.

It is possible to use, as an example of the anti-reflection material 5, a sheet obtained by flocking fibers of rayon, nylon, or polyester on a plastic substrate made, such as from polyester. The material of this kind has a concavo-convex surface of a size not smaller than the wavelength. Therefore, coherence is lost even with respect to a small amount of reflection. Thus, it is possible to prevent generation of interference fringes. Alternatively, it is possible to use black velvet or a radio wave absorbing sheet. Further alternatively, it is possible to intentionally use a material having a micro-structure surface. A motheye structure, which has been attracting attention in recent years, is a preferred example of the aforementioned configuration. Preferably, the anti-reflection material 5 may have light absorption characteristics, which are similar to the characteristics of a black body. This is because a terahertz sensor also detects heat radiation.

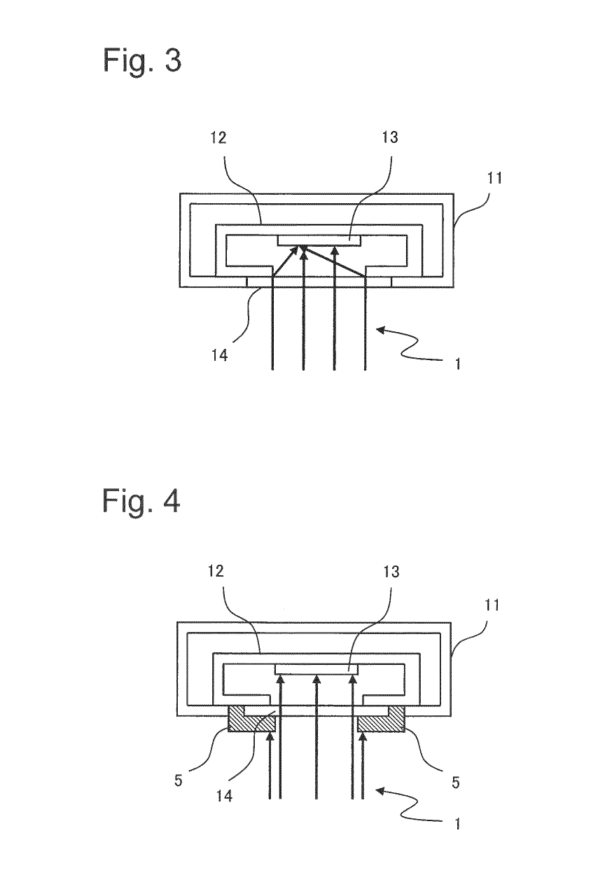

FIG. 3 is a sectional view schematically illustrating interference of unwanted light when the anti-reflection material 5 is not provided in the sensor package 12. When the coherent terahertz light 1 is incident through the window 14, the coherent terahertz light 1 is reflected on the edge of the sensor package 12 in a direction other than the incident direction. Referring to FIG. 3, light reflected on the left end of the opening portion of the sensor package 12, and light reflected on the right end of the opening portion of the sensor package 12 interfere with each other, and an intensity distribution depending on the optical path difference is formed on the array sensor 13. When interference of light concerning the entirety of reflected light is summed up, the intensity distribution of the light is expressed by concentric interference fringes. Because the interference fringes are formed over the image, the quality of the acquired image is deteriorated. On the other hand, as illustrated in FIG. 4, when the anti-reflection material 5 is formed around the window 14 on the outside of the light incident area of the array sensor 13, there is no light which may be reflected on the end of the opening portion of the sensor package 12. Therefore, interference fringes are not generated. Thus, it is possible to acquire a terahertz image free from an influence of unwanted light. Further, the same operations and advantageous effects as described above are obtained in the other optical elements such as the lens holder 8 and the sample holder 10.

As described above, according to the exemplary embodiment, it is possible to eliminate interference of unwanted light to thereby obtain a terahertz image of high image quality.

### Third Exemplary Embodiment

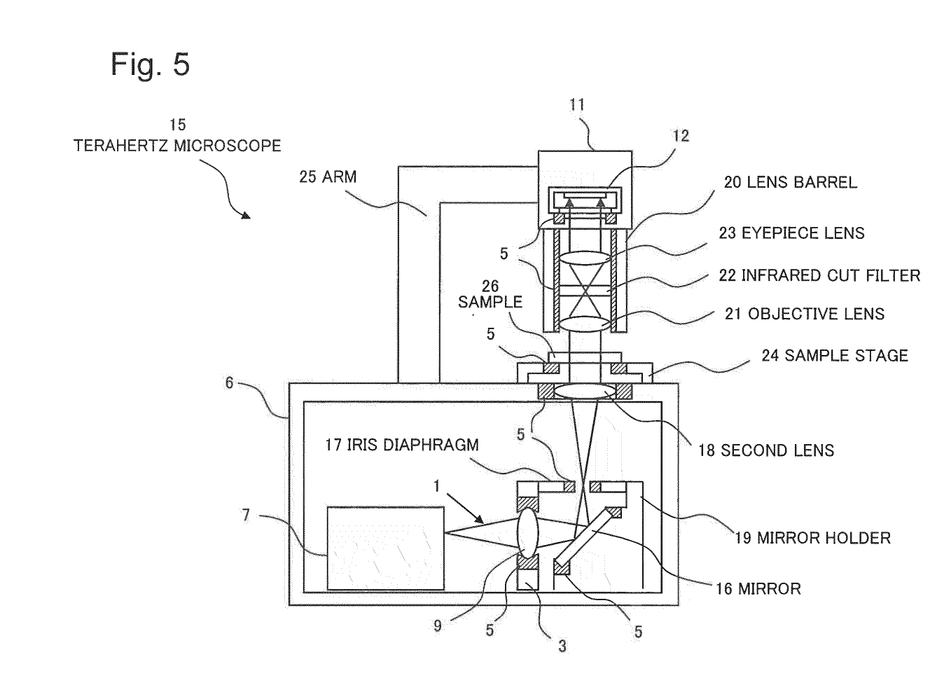

The interference fringe preventing technique of the invention is applicable to various optical devices. FIG. 5 is a sectional view illustrating a terahertz microscope 15 incorporated with the configuration of the invention.

An illumination optical system is provided in a housing 6. The illumination optical system is constituted by a coherent terahertz light source 7, a first lens 9, a mirror 16, an iris diaphragm 17, and a second lens 18. An anti-reflection material 5 is formed on each of a lens holding portion of a lens holder 8 which supports the first lens 9, a mirror holding portion of a mirror holder 19 which supports the mirror 16, a holding portion of the second lens 18, and a terahertz light incident area of the iris diaphragm 17.

An observation optical system is constituted by a lens barrel 20, an objective lens 21 supported on the lens barrel 20, an infrared cut filter 22, an eyepiece lens 23, and a terahertz camera 11. The infrared cut filter 22 cuts infrared light as noise, for instance, light having a frequency of 10 THz or larger. Further, the anti-reflection material 5 is formed on the inner wall of the lens barrel 20 which supports the objective lens 21 and the like. The structure of the terahertz camera 11 is the same as in the second exemplary embodiment. The anti-reflection material 5 is formed around the light incident portion of the terahertz camera 11. Further, a sample stage 24 for mounting a sample is formed between the illumination optical system and the observation optical system. A light transmitting portion for transmitting light is formed on the sample stage 24. The anti-reflection material 5 is formed around the light transmitting portion, as well as the other optical elements. The lens barrel 20 and the terahertz camera 11 are supported by an arm 25. Further, in this example, the optical device is referred to as a microscope. However, the magnification is not necessarily limited to 1 or to a value larger than 1.

Next, an operation to be performed by the terahertz microscope 15 is described.

First, the coherent terahertz light 1 is output from the coherent terahertz light source 7. An example of the coherent terahertz light source 7 is a quantum cascade laser when the frequency of light is 1.5 THz or larger. When the frequency of light is 2 THz or smaller, a Schottky diode multiplier may be used as a light source.

Light output from the coherent terahertz light source 7 is collected by the first lens 9. The collected light is reflected on the mirror 16 in a direction toward the sample stage 24. The reflected light is focused at the position of the iris diaphragm 17, and the focused light is collimated by the second lens 18. The collimated light is irradiated on a sample 26 mounted on the sample stage 24. The iris diaphragm 17 is used for eliminating unwanted light such as light in a high-order mode.

Light transmitted through the sample 26 after having undergone absorption inherent to the sample 26 is collected and collimated by the objective lens 21 and the eyepiece lens 23. The collimated light is incident on the terahertz camera 11. Thus, an image of the sample 26 is formed on an array sensor incorporated in a sensor package 12.

Light that is expanded to the outside of the effective diameter of the optical components such as a lens, a mirror, and a filter while having undergone the aforementioned processes is removed or is made incoherent by the anti-reflection material 5. Thus, it is possible to prevent lowering of the image quality.

### Fourth Exemplary Embodiment

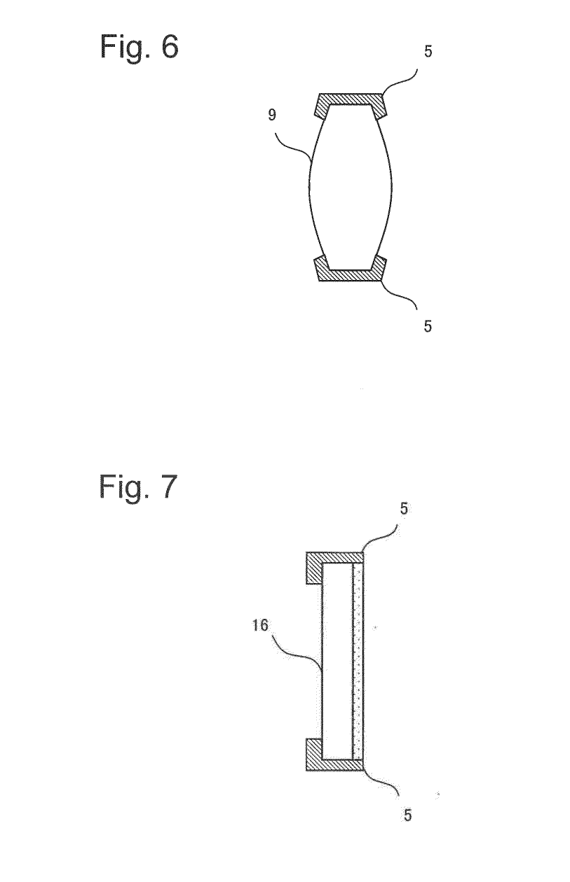

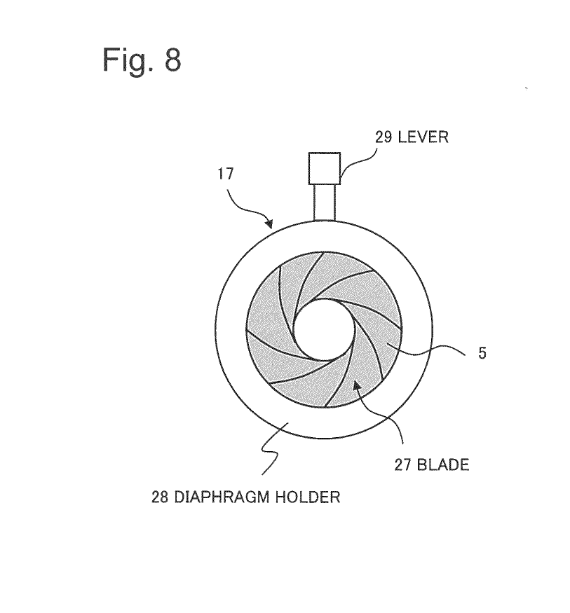

It is possible to regard a lens and a mirror as one optical device. FIG. 6 is a diagram illustrating an example of a lens. A anti-reflection material 5 is formed on the outer periphery of a first lens 9. In this configuration, the effective diameter of an optical system is a diameter of a transparent portion with respect to terahertz light. A structure is the outer periphery of the first lens 9. The anti-reflection material 5 is formed on the outer periphery of the first lens 9. FIG. 7 is a diagram illustrating an example of a mirror. The anti-reflection material 5 is formed on the outer periphery of a mirror 16. FIG. 8 is a plan view illustrating an example of an iris diaphragm 17. Blades 27 are supported on a diaphragm holder 28. The anti-reflection material 5 is formed on the blades 27. Moving the blades 27 by a lever 29 makes it possible to adjust the size of the effective diameter. FIG. 7 depicts that the anti-reflection material 5 is formed on the entire surface of the blades 27. Alternatively, it is also possible to obtain substantially the same advantageous effects as described above when the anti-reflection material 5 is formed solely in the vicinity of the end of the blades, which define the effective diameter. The optical device to which the exemplary embodiment is applied is not limited to the aforementioned configuration. The optical device to which the exemplary embodiment is applied may be various devices such as a fixed diaphragm, a prism, and a diffraction grating.

### EXAMPLE

In this section, an example of an actual observation result is described. An experiment was carried out by linearly disposing a quantum cascade laser, a metal frame devoid of a lens, an infrared cut filter, and a terahertz camera in order to avoid complication of causes of a phenomenon. In the example, the frame can be regarded as a diaphragm whose effective diameter is fixed.

The frequency of output light from the quantum cascade laser was set to 2 THz. The frame that causes interference is a metal frame coated with black anodized aluminum as a surface treatment and having an opening diameter of 30 mm and a length of 20 mm. The infrared cut filter is a filter which blocks transmission of light having a frequency of 10 THz or larger. The terahertz camera is incorporated with an array sensor whose pixel number is 320 by 240, and whose pixel pitch is 23.5 μm. The size of the sensor is 7.52 mm by 5.64 mm. The distance from the light emitting point of the quantum cascade laser to a tip end of the terahertz camera was set to 140 mm. The infrared cut filter was installed at a position in contact with the tip end of the terahertz camera.

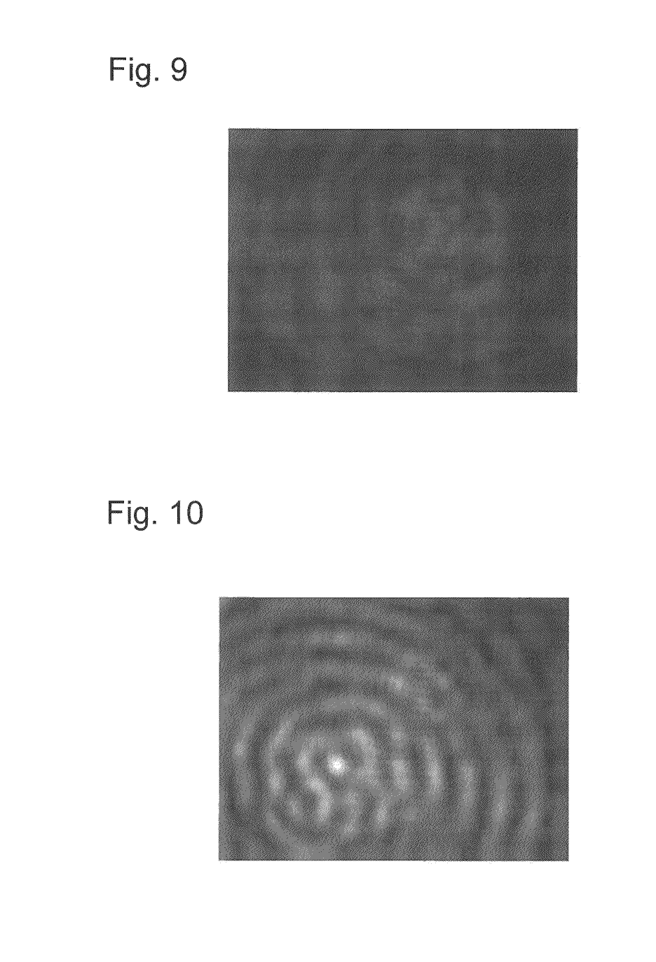

FIG. 9 illustrates a terahertz image obtained when a metal frame is not disposed. Since light is not collected by a lens, the obtained image is dark as a whole.

FIG. 10 illustrates an image captured by the terahertz camera when a metal frame without anti-reflection material is disposed at a position away from the light emitting point by 90 mm, and away from the tip end of the terahertz camera by 50 mm. Since reflected light from the metal frame is also incident, the image is bright as a whole. Further, reflected light from the circular frame and light that has been transmitted through the frame interfere with each other. As a result, concentric interference fringes are generated.

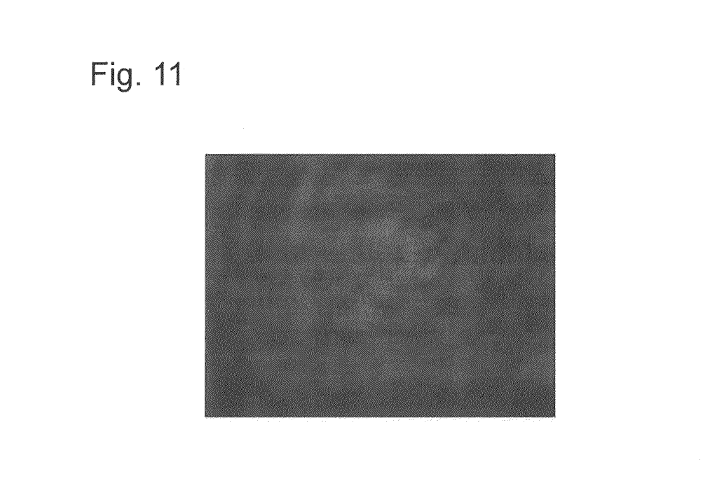

FIG. 11 is a diagram illustrating a terahertz image obtained when an anti-reflection material is formed on the inside of a metal frame. Since reflection from the metal frame is prevented, an obtained image is the same as the image illustrated in FIG. 9, in which a metal frame is not disposed. It is clear that generation of interference fringes is sufficiently prevented. The anti-reflection material is a film obtained by electrostatically flocking nylon fibers dyed in black and having a length of 1 mm on a polyester substrate.

Use of the aforementioned flocked film causes the light to lose coherence even with respect to a small amount of reflection, and makes it possible to prevent generation of interference fringes, because the film has a concavo-convex surface of a size larger than 150 μm, which is the wavelength of light.

### Fifth Exemplary Embodiment

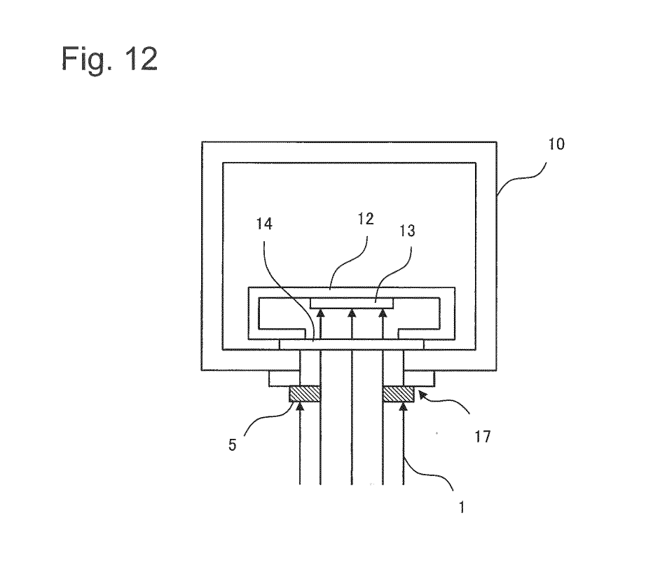

FIG. 12 is a sectional view illustrating the fifth exemplary embodiment of the invention. The exemplary embodiment relates to a terahertz camera 10. The terahertz camera 10 is provided with an iris diaphragm 17 at an incident portion of the terahertz camera 10 where coherent terahertz light 1 is incident. The iris diaphragm 17 is configured to increase or decrease the inner diameter of the iris diaphragm 17 by moving vanes 27. Anti-reflection material 5 is formed on the inner end of the vanes 27. Use of the iris diaphragm 17 makes it possible to prevent irradiation of terahertz light on a reflective element such as an end of a window 14 or an end of a sensor package 12. Thus, it is possible to prevent lowering of image quality by interference of unwanted light. In FIG. 12, the iris diaphragm 17 is supported by a housing of the terahertz camera 10. Alternatively, the iris diaphragm 17 may be supported by another holder.

### Sixth Exemplary Embodiment

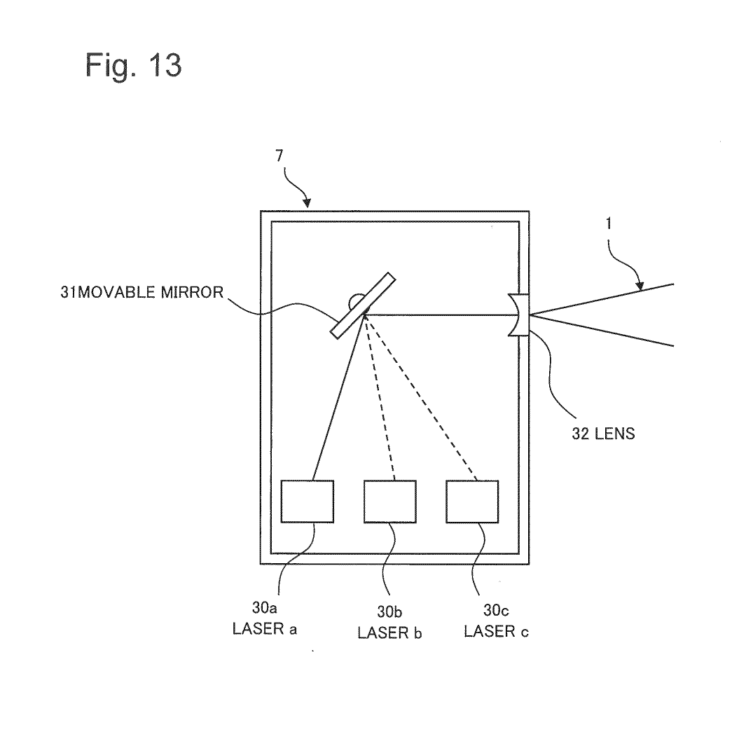

FIG. 13 is a sectional view illustrating an optical device in the sixth exemplary embodiment. The optical device in the exemplary embodiment is configured such that a coherent terahertz light source 7 is operative to output terahertz light of a plurality of types whose frequencies are different from each other. Constituent elements to be disposed on the outside of the coherent terahertz light source 7 such as an optical system and a terahertz camera are the same as those in the other exemplary embodiments, and therefore, description is omitted herein.

The coherent light source 7 is provided with a plurality of lasers 30 whose frequencies are different from each other. In this example, the lasers 30 are a laser a 30a, a laser b 30b, and a laser c 30c. It is possible to select any of the lasers 30 for outputting light by a movable mirror 31. Terahertz light reflected on the movable mirror 31 is output at a predetermined output angle by the operation of a lens 32. The number of lasers 30 to be used is not limited to three. Further, the light source to be used is not limited to a laser. Means for switching the frequency of light to be output is not limited to the movable mirror 31. It is possible to apply different variations by using a well-known technique, such as simultaneously turning on a plurality of light sources and switching between filters or slits.

Use of terahertz light having different frequencies as described above makes it possible to specify a material from the absorption characteristics inherent to the material. Specifically, it is possible to acquire a fingerprint spectrum of a sample.

### Seventh Exemplary Embodiment

As described in the sixth exemplary embodiment, the invention is applicable to an optical device which acquires a fingerprint spectrum. A baggage inspection device is proposed as an example of the device utilizing the aforementioned feature.

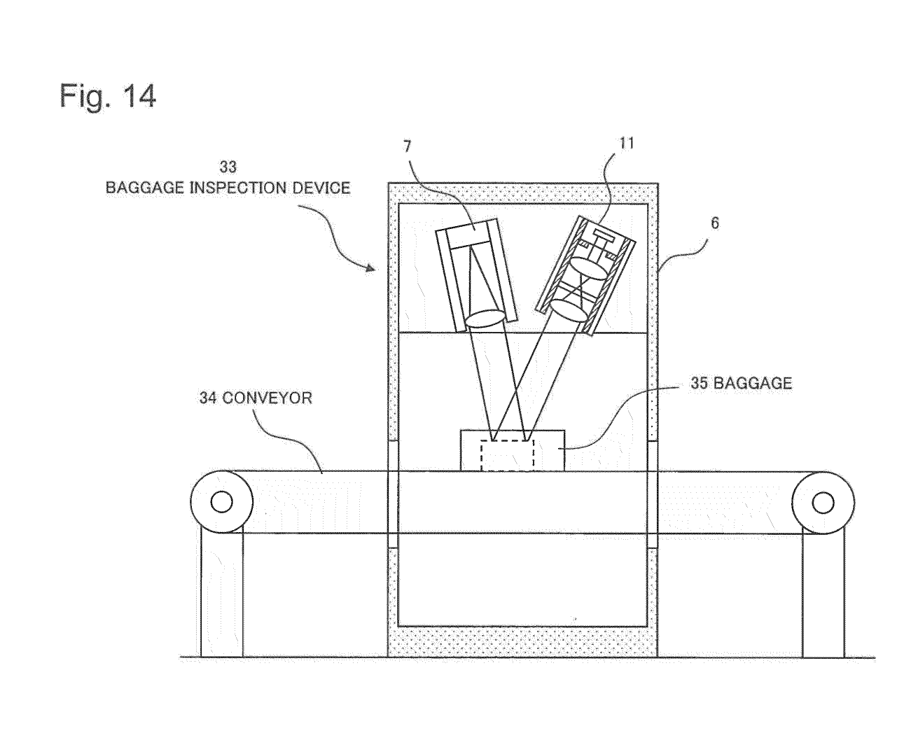

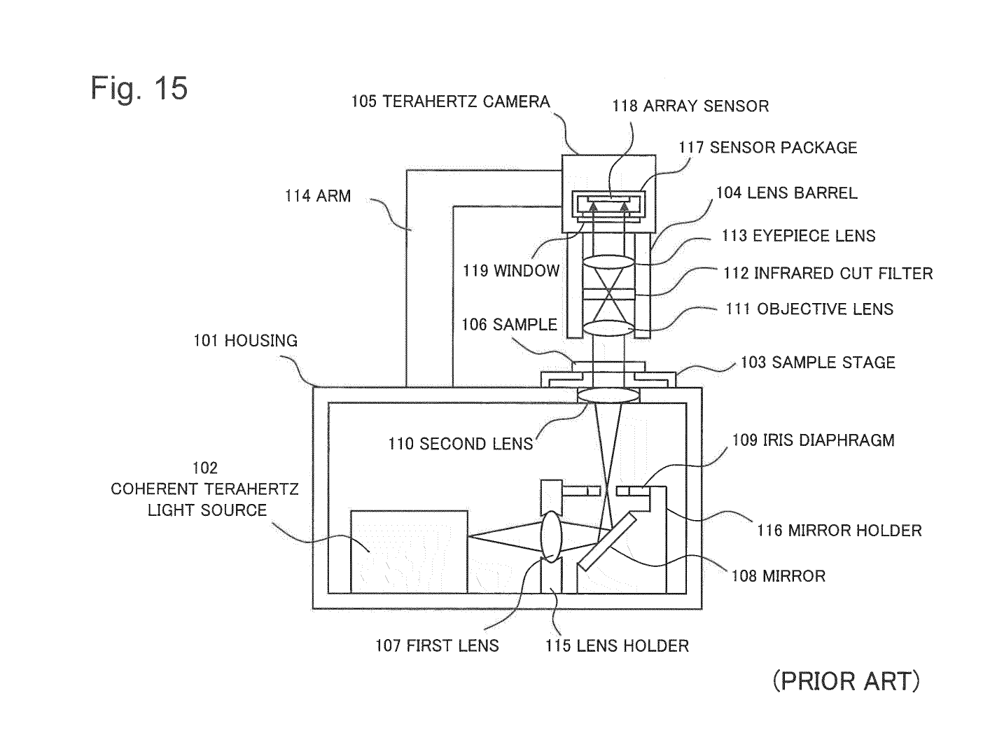

FIG. 14 is a schematic diagram illustrating a baggage inspection device 33 in the exemplary embodiment. A coherent terahertz light source 7 and a terahertz camera 11 are provided in a housing 6. Disposing the coherent terahertz light source 7 and the terahertz camera 11 at positions capable of reflecting light makes it possible to acquire a terahertz image of a baggage 35 moving on a conveyor 34.

Terahertz light has a feature of transmitting through paper or plastic. Therefore, it is possible to inspect the inside of the baggage that cannot be viewed by visible light. Further, it is possible to check whether illegal drugs or the like are transported by using a fingerprint spectrum. Although not described in details in the specification, the device may be configured such that light is transmitted. Further, an object to be inspected is not limited to the baggage 35. For instance, it is possible to use the optical device in the exemplary embodiment for inspecting fruits, vegetables, medicines, chemicals, and the like.

The invention of the present application has been described as above with reference to the exemplary embodiments and examples. The invention of the present application, however, is not limited to the exemplary embodiments and examples. The configuration and details of the invention of the present application may be modified in various ways comprehensible to a person skilled in the art in the scope of the invention of the present application.

This application claims the priority based on Japanese Patent Application No. 2013-137713 filed on Jul. 1, 2013, and all of the disclosure of which is hereby incorporated.

### REFERENCE SIGNS LIST

1 Coherent terahertz light
2 Optical system
3 Effective diameter
4 Structure
5 anti-reflection material
6, 101 Housing
7, 102 Coherent terahertz light source
8, 115 Lens holder
9, 107 First lens
10 Sample holder
11,105 Terahertz camera
12, 117 Sensor package
13, 118 Array sensor
14, 119 Window
15 Terahertz microscope
16, 108 Mirror
17, 109 Iris diaphragm
18, 110 Second lens
19, 116 Mirror holder
20, 104 Lens barrel
21, 111 Objective lens
22, 112 Infrared cut filter
23, 113 Eyepiece lens
24, 103 Sample stage
25, 114 Arm
26, 106 Sample
27 Blade
28 Diaphragm holder
29 Lever
30 Laser
31 Movable mirror
32 Lens
33 Baggage inspection device
34 Conveyor
35 Baggage

What is claimed is:

1. An optical device for coherent terahertz light, comprising:
an optical system that uses coherent terahertz light beam whose frequency(ies) is/are within a range from 0.1 to 10 THz; and
a structure(s) being located outside of effective diameter of the beam and including anti-reflection material on an area(s) of the structure, the area(s) is/are facing to the beam.

2. The optical device for coherent terahertz light according to claim 1, wherein
the effective diameter is included in a ray tracing area by geometric optics.

3. The optical device for coherent terahertz light according to claim 1, wherein
the optical device includes a light sensor which senses the coherent terahertz light.

4. The optical device for coherent terahertz light according to claim 1 wherein
the optical device includes a coherent terahertz light source which outputs the coherent terahertz light.

5. The optical device for coherent terahertz light according to claim 4, wherein
the coherent terahertz light source selectively outputs a plurality of the coherent terahertz light having frequencies different from each other.

6. The optical device for coherent terahertz light according to claim 1, wherein
the structure is a diaphragm.

7. The optical device for coherent terahertz light according to claim 1, wherein
the optical device is a lens or a mirror.

8. The optical device for coherent terahertz light according to claim 1, wherein
the optical device is a light sensor which senses the coherent terahertz light, and
the structure includes a housing which accommodates a light sensing unit of the light sensor.

9. The optical device for coherent terahertz light according to claim 8, wherein
the light sensor includes the light sensing unit being configured such that light sensing elements are arranged in an array.

10. The optical device for coherent terahertz light according to claim 9, wherein
the anti-reflection material is formed on an end of a light incident portion of the light sensing unit.
